(19) United States
(12) Patent Application Publication
(10) Pub. No.: US 2022/0025745 A1
(43) Pub. Date: Jan. 27, 2022

(54) NOZZLE FOR GAS CHOKING

(71) Applicant: RGL Reservoir Management Inc., Calgary (CA)

(72) Inventor: Da Zhu, Calgary (CA)

(21) Appl. No.: 17/281,133

(22) PCT Filed: Jan. 10, 2019
(86) PCT No.: PCT/CA2019/051407

§ 371 Date: Mar. 29, 2021

Related U.S. Application Data
(60) Provisional application No. 62/739,630, filed on Oct. 1, 2018.

(51) Int. Cl. E21B 43/12; E21B 43/08

(52) U.S. Cl. CPC E21B 43/12; E21B 43/08

(57) ABSTRACT

A nozzle for controlling the flow of a gas component of a fluid produced from a hydrocarbon-bearing reservoir, the fluid comprising oil and gas, comprises a fluid passage extending between an inlet and an outlet, wherein the fluid passage comprises a constriction for choking the flow of the gas component of the fluid.

### CROSS REFERENCE TO RELATED APPLICATIONS

This application claims priority under the Paris Convention to U.S. Application No. 62/739,630, filed on Oct. 1, 2018, and PCT Application Number PCT/CA2019/051407, filed on Oct. 1, 2019, which are incorporated herein by reference in their entirety.

### FIELD OF THE DESCRIPTION

The present description relates to nozzles, or flow control devices, used for controlling flow of fluids into a tubular member. In a particular aspect, the nozzles are adapted for use on tubular members used for producing hydrocarbons from subterranean reservoirs. More particularly, the described flow control devices assist in choking or limiting the flow the gas from a reservoir into production tubing.

### BACKGROUND

Subterranean hydrocarbon reservoirs are generally accessed by one or more wells that are drilled into the reservoir to access the hydrocarbon materials. Such materials (which may be referred to simply “hydrocarbons”) are then pumped to the surface through production tubing. The wells drilled into the reservoirs may be vertical or horizontal or at any angle there-between.

In conventional hydrocarbon production methods, the wells are drilled into a hydrocarbon containing reservoir and the hydrocarbon materials are brought to surface using, for example, pumps etc. In some cases, such as where the hydrocarbons comprise a highly viscous material, such as heavy oil and the like, enhanced oil recovery, or “stimulation”, methods may be used. Steam Assisted Gravity Drainage, “SAGD” and Cyclic Steam Stimulation, “CSS”, are examples of these methods. Such methods serve to increase the mobility of the desired hydrocarbons and thereby facilitate the production thereof. In a SAGD operation, a number of well pairs, each typically comprising a horizontal well, are drilled into a reservoir. Each of the well pairs comprises a steam injection well and a production well, with the steam injection well being positioned generally vertically above the production well. In operation, steam is injected into the injection well and the heat from such steam dissipates into the surrounding formation and reduces the viscosity of hydrocarbon material, typically heavy oil, in the vicinity of the injection well. After steam treatment, the hydrocarbon material, now mobilized, drains into the lower production well by gravity, and is subsequently brought to the surface through the production tubing. In a CSS process, a single well may be used to first inject steam into the reservoir through tubing, generally production tubing. After the steam injection stage, the heat from the steam is allowed to be absorbed into the reservoir, a stage referred to as “shut in” or “soaking”, during which the viscosity of the neighbouring hydrocarbon material is reduced thereby rendering such material more mobile. Following the shut in stage, the hydrocarbons are produced through the well in a production stage.

Tubing used in wellbores typically comprises a number of segments, or tubulars, that are connected together. Various tools (such as packers, sleeves, downhole telemetry devices etc.) may also be provided at one or more positions along the length of the tubing and connected inline with adjacent tubulars. The tubing, for either steam injection and/or hydrocarbon production, generally includes a number of apertures, or ports, along its length. The ports provide a means for injection of steam and/or other viscosity reducing agents, and/or for the inflow of hydrocarbon materials from the reservoir into the pipe and thus into the production tubing. The segments of tubing having ports are also often provided with one or more filtering devices, such as sand screens, which serve to prevent or mitigate against sand and other solid debris in the well from entering the tubing.

In reservoirs containing a combination of oil and gas, one of the problems often encountered is the preferential flow, or “production”, of the more mobile gas component over the less mobile liquid oil component. Being non-condensable, the gas component remains in the gaseous and therefore less dense state, thereby leading to its preferential production at one or more locations along the length of the production tubing. As known in the art, the issue of “gas coning” is commonly encountered where such preferential gas production occurs.

To address the problem of preferential gas production, nozzles, also referred to as inflow control devices, ICDs, may be employed on the production tubing. Examples of known ICDs designed for restricting undesired production of gas and like components are provided in: US 2017/0044868; U.S. Pat. No. 7,537,056; US 2008/0041588; and, U.S. Pat. No. 8,474,535. Many of these ICDs involve the use of moving elements to dynamically adjust to local fluid compositions and are therefore relatively complicated.

Apart from gas flow control devices mentioned above, various nozzles or ICDs are known in the art for restricting, or choking, the flow of steam into production tubing. Such devices are, however, specifically designed to take advantage of the condensable nature of steam, which can be flashed from water. On the other hand, gas is a non-condensable fluid and, as such, nozzles designed for steam control typically cannot be used to control or choke the flow of gas.

Many of the ICDs mentioned above are provided in association with sand screens, which are discussed above. In such case, the ICDs are provided in combination with the sand screen/tubing assembly and situated adjacent ports on the tubing to thereby filter fluids entering the tubing.

There exists a need for an improved nozzle, or ICD, to control or limit, i.e. choke, the production of gas from a reservoir.

### SUMMARY OF THE DESCRIPTION

In one aspect, there is provided a nozzle for limiting or choking the flow of gas into a pipe, the pipe having at least one port along its length, the nozzle being adapted to be located on the exterior of the pipe and adjacent one of the at least one port, the nozzle comprising first and second openings and a fluid passage extending there-between, and wherein the fluid passage includes converging and diverging sections.

In one aspect, there is provided a nozzle for controlling flow of a gas component, of a fluid comprising a mixture of oil and gas, into a pipe, the pipe having at least one port along its length, the nozzle being adapted to be located on the exterior of the pipe and adjacent one of the at least one port, the nozzle comprising:
a body having an inlet, an outlet, and a fluid conveying passage extending between the inlet and outlet;
wherein, the passage comprises:
a first region having a converging-diverging region forming a throat, the throat being proximal to the inlet and defining a constriction in the passage; and,
a second region downstream of the first region having a gradually increasing cross-sectional area extending towards the outlet.

In another aspect, there is provided an apparatus for controlling flow, from a subterranean reservoir, of a gas component, of a fluid comprising a mixture of oil and gas, the apparatus comprising:
a pipe segment having at least one port along its length;
at least one nozzle located on the exterior of the pipe and adjacent one of the at least one port; and,
and a means for locating the nozzle on the pipe adjacent the port;
wherein the nozzle comprises:
a body having an inlet, an outlet, and a fluid conveying passage extending between the inlet and outlet;
wherein, the passage comprises:
a first region having a converging-diverging region forming a throat, the throat being proximal to the inlet and defining a constriction in the passage; and,
a second region downstream of the first region having a gradually increasing cross-sectional area extending towards the outlet.

In another aspect, there is provided a method of producing fluids from a subterranean reservoir, the method comprising:

a) flowing the fluids through a first, converging-diverging region of a nozzle; and

b) flowing the fluids through a second, diverging region of the nozzle, wherein the second region has a gradually increasing cross-sectional area.

### BRIEF DESCRIPTION OF THE FIGURES

The features of certain embodiments will become more apparent in the following detailed description in which reference is made to the appended figures wherein:

FIG. 1 is a side cross-sectional view of a flow control nozzle according to an aspect of the present description.

FIG. 2 is an end view of the nozzle of FIG. 1, showing the inlet thereof.

FIG. 3 is a side view of the nozzle of FIG. 1.

FIG. 4 is a side cross-sectional view of a flow control nozzle according to an aspect of the present description, in combination with a pipe.

FIG. 5 is a partial cross-sectional schematic view of a flow control nozzle according to another aspect of the present description.

FIG. 6 illustrates the pressure drop across the length of a nozzle having different positions of a constriction or throat.

FIG. 7 illustrates the mass flow rate and pressure curves for flow through a nozzle as described herein and an orifice.

### DETAILED DESCRIPTION

As used herein, the terms “nozzle” or “nozzle insert” will be understood to mean a device that controls the flow of a fluid flowing there-through. In one example, the nozzle described herein serves to control the flow of a fluid through a port in a pipe in at least one direction. More particularly, the nozzle described herein comprises an inflow control device, or ICD, for controlling the flow of fluids into a pipe through a port provided on the pipe wall.

The terms “regulate”, “limit”, “throttle”, and “choke” may be used herein. It will be understood that these terms are intended to describe an adjustment of the flow of a fluid passing through the nozzle described herein. The present nozzle is designed to choke the flow of a fluid, in particular a low viscosity fluid, such as non-condensable gas, such as CH₄ and CO2, flowing from a reservoir into a pipe. The flow of a fluid through a passage is considered to be “choked” when a further decrease in downstream pressure does not result in an increase in the mass flow rate of the fluid. Choked flow is also referred to as “critical flow”. Such choked flow is known to arise when the passage includes a reduced diameter section, or throat, such as in the case of convergent-divergent nozzles. In such nozzles, the flowing fluid accelerates, with a resulting reduction in pressure, as it moves towards and flows through the throat, and subsequently decelerates, and recovers pressure, in the diverging section downstream of the throat. In the special case where the fluid velocity at the throat approaches the local sonic velocity, i.e. Mach 1, the mass flow rate of the fluid cannot increase further for a given inlet pressure and temperature, despite a reduction in outlet or downstream pressure. In other words, the fluid flow rate remains unchanged even where the downstream pressure is decreased.

The term “hydrocarbons” refers to hydrocarbon compounds that are found in subterranean reservoirs. Examples of hydrocarbons include oil and gas. For the purposes of the present description, the desired hydrocarbon component is oil.

The term “wellbore” refers to a bore drilled into a subterranean formation, such as a formation containing hydrocarbons.

The term “wellbore fluids” refers to hydrocarbons and other materials contained in a reservoir that are capable of entering into a wellbore. The present description is not limited to any particular wellbore fluid(s).

The terms “pipe” or “base pipe” refer to a section of pipe, or other such tubular member. The base pipe is generally provided with one or more ports or slots along its length to allow for flow of fluids there-through.

The term “production” refers to the process of producing wellbore fluids, in particular, the process of conveying wellbore fluids from a reservoir to the surface.

The term “production tubing” refers to a series of pipe segments, or tubulars, connected together and extending through a wellbore from the surface into the reservoir.

The terms “screen”, “sand screen”, “wire screen”, or “wire-wrap screen”, as used herein, refer to known filtering or screening devices that are used to inhibit or prevent sand or other solid material from the reservoir from flowing into the pipe. Such screens may include wire wrap screens, precision punched screens, premium screens or any other screen that is provided on a base pipe to filter fluids and create an annular flow channel. The present description is not limited to any particular screen described herein.

The terms “comprise”, “comprises”, “comprised” or “comprising” may be used in the present description. As used herein (including the specification and/or the claims), these terms are to be interpreted as specifying the presence of the stated features, integers, steps or components, but not as precluding the presence of one or more other features, integers, steps, components or a group thereof, as would be apparent to persons skilled in the relevant art.

In the present description, the terms “top”, “bottom”, “front” and “rear” may be used. It will be understood that the use of such terms is purely for the purpose of facilitating the description of the embodiments described herein. These terms are not intended to limit the orientation or placement of the described elements or structures in any way.

In general, the present description relates to a flow control device, or nozzle, that serves to control or regulate the flow of fluids between a reservoir and a base pipe, or section of production tubing. As discussed above, in one aspect, such regulation is often required in order to preferentially produce a desired hydrocarbon material over undesired fluids. For the purpose of the present description, it is desired to produce oil and to limit the production of gas contained in a reservoir. As discussed above, the gas component in a reservoir, being more mobile than the oil component, more easily travels towards and into the production tubing. Thus, regulation of the gas flow is desirable in order to increase the oil to gas production ratio.

Generally, the nozzle, or ICD, described herein serves to choke the flow of gas from the reservoir into production tubing. More particularly, the presently described nozzle incorporates a unique geometry based on the different fluid dynamic properties of non-condensable gas and liquid hydrocarbons so as to choke the flow of gas while allowing the liquid phase to flow relatively unimpeded. The nozzle described herein may be used in any type of process, including conventional oil extraction operations as well as enhanced oil recovery operations, such as a SAGD or CSS operation.

The nozzle described herein is designed to “choke back” the flow of gas into production tubing, that is, to preferentially increase the ratio of liquid (i.e. primarily oil) to gas flow rates, assuming a given pressure differential across the nozzle. Thus, the presently described nozzle is designed with the aim of maintaining or increasing the flow rate of the liquid (primarily oil) component from a reservoir into production tubing while decreasing or limiting the flow rate of the gas component. For this purpose, the nozzle described herein comprises an inlet and an outlet and a flow path, or passage, there-between, the passage having two primary sections: a first section comprising a converging portion or portion having a gradually decreasing cross-sectional area, located proximal to the inlet; and, a second section, downstream of the first section, comprising a diverging portion, preferably having a gradually increasing cross-sectional area. The converging portion includes a constriction, comprising a region of the passage having the smallest cross-sectional area. The nozzle may also include a third section comprising a region of constant cross-sectional area proximal to the outlet.

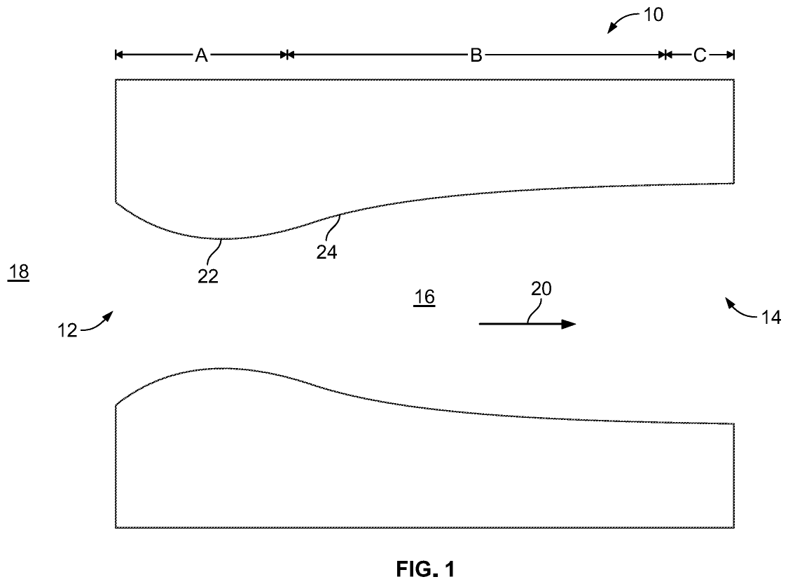

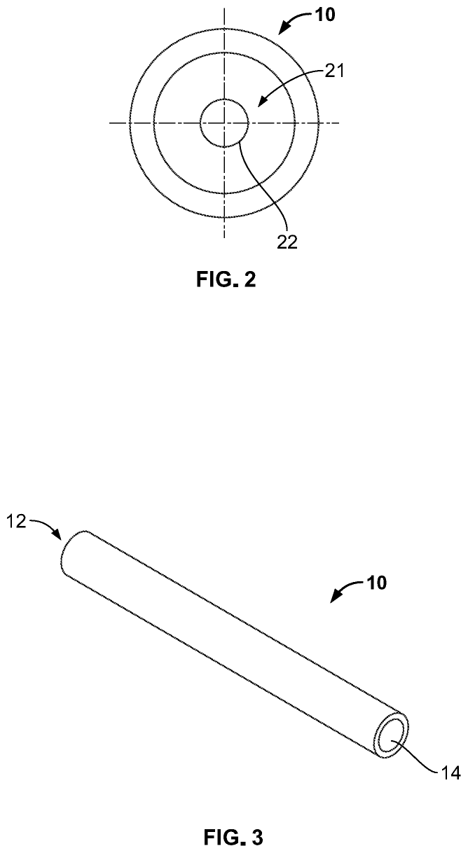

FIGS. 1 to 3 illustrate one aspect of a nozzle according to the present description. As shown, the nozzle, or ICD, 10 comprises a generally tubular body having a first opening or inlet 12 and a second opening or outlet 14 and a passage 16 extending there-through. When in use during production, reservoir fluids, including oil and gas components, flow from the reservoir 18, and through the nozzle 10, in the direction shown by arrow 20, and subsequently into production tubing provide in a well. The inlet 12 is adapted to receive fluids from the reservoir 18 while the outlet 14 is adapted to allow such fluids to flow into the production tubing. It will be understood that the outlet 14 is in fluid communication with a port provided on the production tubing. Thus, the outlet 14 may feed directly into such port or a diverter or other such device may be provided to conduct the fluid from the outlet 14 into the port.

As illustrated in FIG. 1, the passage 16 of the nozzle 10 preferably comprises two primary regions: (1) a throat region, A, adjacent and downstream from the first opening 12, the throat comprising a convergent portion 21, starting at the first opening 12, and a constriction 22 downstream thereof; and (2) a divergent region, B, having a gradually increasing cross-sectional area along the flow direction 20. The divergent region B, downstream of the throat region A, is preferably provided with a smooth or curved wall 24 that gradually expands to create the increasing cross-sectional area along the flow direction 20.

In one aspect, that region B may terminate in a constant cross-sectional area region, C, immediately adjacent the second opening 14. In other aspects, the divergent region B may extend completely to the second opening 14 without a constant cross-sectional area region.

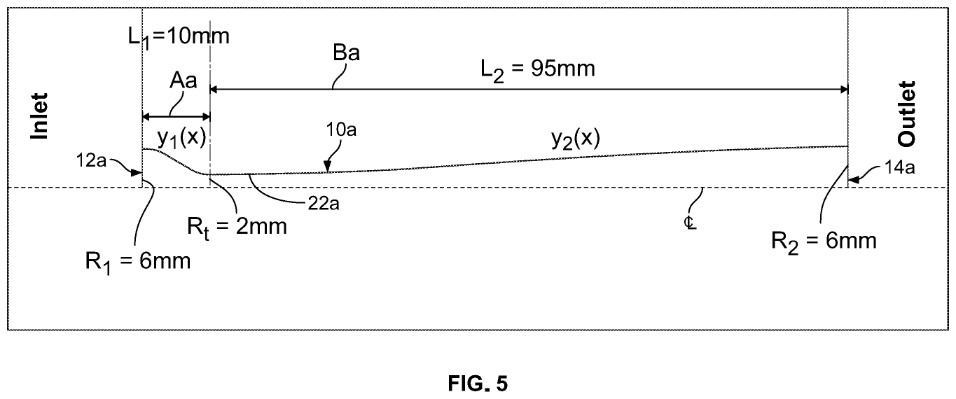

The convergent portion 21 of throat region A comprises a section of the passage 16 where the cross-sectional area gradually reduces along the direction of arrow 20. As mentioned above, the throat region A is provided with a constriction, or vena contracta, 22, which is the point along the passage 16 having the smallest cross-sectional area. The length of the constriction 22 may vary. For example, as shown in FIG. 1 (and also in FIG. 5 discussed below), the constriction 22 may be short, as compared to the length of the passage 16, thereby forming a smooth transition between the convergent portion 21 of region A and the wall 24 of the divergent region B. Alternatively, the constriction 22 may have a longer length, in which case, the constriction 22 may include a region where the cross-sectional area of the passage 16 is generally constant.

As will be understood, the length of the convergent portion 21 of the throat region A may vary. As illustrated in FIG. 1, the convergent portion 21 may be relatively short, in which case the constriction 22 is located close to the first opening or inlet 12. In other aspects, the convergent portion 21 may be longer, in which case the constriction 22 may be located further away from the inlet 12. In either case, the constriction 22 is followed by a divergent region B for the reasons provided herein.

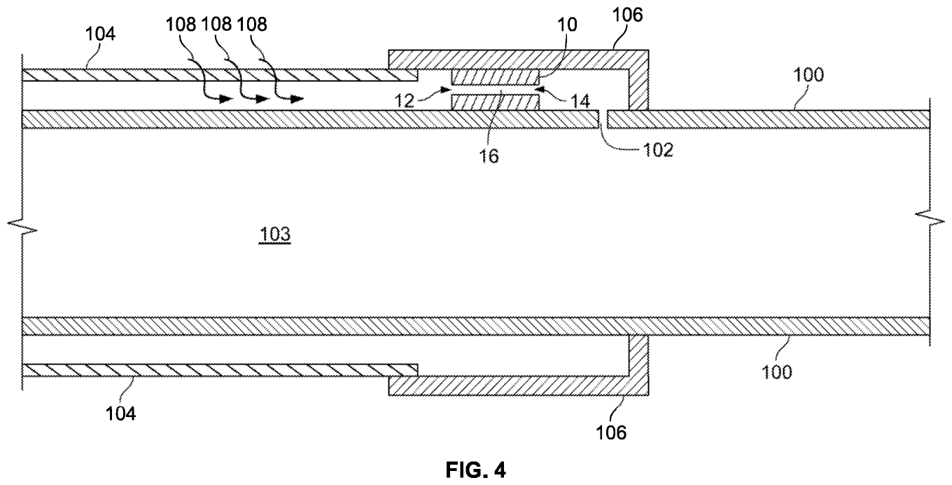

FIG. 4 schematically illustrates a pipe 100 that is provided with a nozzle 10 as described herein. As shown, the pipe 100 comprises an elongate tubular body having a number of ports 102 along its length. The ports 102 allow fluid communication between the exterior of the pipe and its interior, or lumen, 103 (which is generally shown as 16 in FIG. 1). As is common, pipes used for production (i.e. production tubing) typically include a screen 104, such as a wire-wrap screen or the like, for screening fluids entering the pipe. The screen 104 serves to prevent or filter sand or other particulate debris from the wellbore from entering the pipe. Typically, the screen 104 is provided over the surface of the pipe 100 and is retained in place by a collar 106 or any other such retaining device or mechanism. It will be understood that the present description is not limited to any type of screen 104 or screen retaining device or mechanism 106. The present description is also not limited to any number of ports 102. Furthermore, it will be appreciated that while the presence of a screen 104 is shown, the use of the presently described nozzle is not predicated upon the presence of such screen. Thus, the presently described nozzle may be used on a pipe 100 even in the absence of any screen 104. As would be understood, in cases where no screen is used, a retaining device, such as a clamp 106 or the like, will be utilized to secure nozzle 10 to the pipe 100. Alternatively, the nozzle 10 may be secured to the pipe in any other manner as would be known to persons skilled in the art.

As shown in FIG. 4, a nozzle according to the present description is shown generally at 10. It will be understood that the illustration of nozzle 10 is, for convenience, schematic and is not intended to limit the structure of the nozzle to any particular shape or structure. Thus, the nozzle 10 of FIG. 4 may consist of the nozzle described herein, including that shown in the accompanying figures, or any other nozzle configuration in accordance with the present description.

As shown in FIG. 4, the nozzle 10 is positioned on the outer surface of the pipe 100 and located proximal to the port 102. In general, the nozzle 10 is positioned in the flow path of fluids entering the port 102 so that such fluids must first pass through the nozzle before entering the port 102.

It will be understood that the nozzle 10 may be positioned over the pipe 100 in any number of ways. For example, in one aspect, the outer surface of the pipe 100 may be provided with a slot into which the nozzle 10 may be located. The nozzle 10 may be welded or otherwise affixed to the pipe 100 or retained in place with the retaining device 106 as discussed above.

In assembling the apparatus incorporating a sand screen, the pipe 100 is provided with the nozzle 10 and the screen 104 and the associated retaining device 106. The pipe 100 is then inserted into a wellbore.

During the production stage, wellbore fluids, also referred to as production fluid, as illustrated by arrows 108, pass through the screen 104 (if present) and are diverted to the nozzle 10. The production fluid enters the first opening or inlet 12 of the nozzle 10 and flows through the passage 16 as described above, finally exiting through the second opening or outlet 14, to subsequently enter into the port 102 and, thereby, into the lumen 103 of the pipe 100. The fluid is then brought to the surface using commonly known methods.

As would be understood by persons skilled in the art, the nozzles described herein are designed, in particular, to be included as part of an apparatus associated with tubing, an example of which is illustrated in FIG. 4. That is, the nozzles are adapted to be secured to tubing, at the vicinity of one or more ports provided on the tubing. The nozzles are retained in position by any means, such as by collars or the like commonly associated with sand control devices, such as wire wrap screens etc. In another aspect, the present nozzles may be located within slots or openings cut into the wall of the pipe or tubing. It will be understood that the means and method of securing of the nozzle to the pipe is not limited to the specific descriptions provided herein and that any other means or method may be used, while still retaining the functionality described herein.

Referring again to FIG. 1, and as would be understood, a fluid passing through constriction 22 of the throat region A would be accelerated with a resulting reduction in its pressure and density immediately downstream of the constriction. By appropriately sizing the throat region A, based for example on known parameters (as discussed further below), it is possible to have the fluid flowing there-through reach a velocity equal to the local sonic speed, i.e. Mach 1. In this way, the size of the constriction 22 can be calibrated for achieving sonic velocity of the gas component of the reservoir fluid at the constriction 22, and preferably to also achieve supersonic velocity of the gas component downstream of the constriction 22. When the gas reaches sonic velocity at the constriction 22, its mass flow rate, by virtue of its compressible nature, will not be increased with any further reduction in downstream pressure. In other words, in such state, the flow of the gas component through the constriction 22, and therefore the nozzle 10, is choked. However, the liquid component of the reservoir fluids would not be impeded in this manner and, as such, the flow rate ratio of oil to gas can be increased through the nozzle 10.

As mentioned above, the throat region A can be sized, or calibrated, to achieve the desired sonic velocity of the gas component. In this regard, it will be understood that such sizing can be accomplished based on parameters that would be known to persons skilled in the art, such as: the composition of the fluids in the reservoir; the reservoir pressure and temperature; the target liquid (i.e. oil) production rate; the expected pressure drop across the nozzle; and, the reservoir heterogeneity. It will be understood that these are only some of the parameters that may be considered when designing the dimensions of the subject nozzle. It will, however, be understood that although the specific dimensions may vary based on such parameters, the overall structure of the subject nozzle is unique.

The diverging region B of the nozzle 10 primarily serves to increase the mass flow rate of the liquid, i.e. oil, component of the reservoir fluids. In particular, the aim of the diverging section B is to rapidly achieve laminar flow of the liquid component of the fluid flowing through the nozzle 10 after the liquid passes the constriction 22. As known to persons skilled in the art, the pressure drop of a flowing fluid is proportional to the square of the velocity (i.e. ΔP α v²) for turbulent flow, whereas the pressure drop is directly proportional to the velocity (i.e. ΔP α v) for laminar flow. Thus, achieving laminar flow of the liquid component immediately or very shortly following the constriction 22 is desired in order to minimize the pressure differential of the liquid along the passage 16. In turn, the mass flow rate of the liquid component through the nozzle 10 is thereby increased.

In a preferred aspect, the angle of divergence of the wall 24 of region B is less than or equal to about 15 degrees. As would be understood by persons skilled in the art, a divergence angle of this value allows for a desired recovery of the fluid pressure. Further, as will also be understood by persons skilled in the art, a divergence angle of the wall 24 that is greater than about 15 degrees may result in boundary layer separation (i.e. separation of the liquid layer adjacent the wall 24), which would, in turn, result in unwanted pressure reduction.

In addition, the length of the region B, or the combined length of regions B and C where a region C is provided, is preferably sized to be long enough to allow the liquid portion of the fluid flowing through the nozzle to rapidly reach a laminar flow state (for the reasons provided above). However, as would be understood by persons skilled in the art, the length of region B (or regions B and C) would preferably be short enough so as to allow the flowing liquid to exit the outlet 14 as soon a laminar flow is reached. As would be understood, particularly for a viscous fluid such as oil, a longer residence time within the nozzle would result in a reduction in the fluid velocity due to boundary layer effects.

FIG. 5 illustrates one example of a nozzle according to the present description, wherein elements previously described are identified with the same reference numeral but with the suffix “a” added for clarity. As shown, the nozzle 10a of FIG. 5 includes a converging region Aa and a diverging region Ba. As shown, the inlet 12a of the nozzle 10a is provided with a straight-edged contour, as compared to the beveled-edge contour of the inlet 12 described above. As also shown, unlike the nozzle illustrated in FIG. 1, the nozzle 10a of FIG. 5 does not include a constant cross-sectional area C downstream of the region B. Thus, as shown the nozzle includes a gradually increasing cross-sectional area from the constriction 22 to the second opening or outlet 14.

FIG. 5 also illustrates exemplary dimensions of one aspect of the nozzle 10a described herein, which is suitable for use in producing an oil and gas fluid from a reservoir. Table 1 below lists the dimensions of the example of FIG. 5 (“Example 1”) as well as another example of generally the same overall geometry (“Example 2’). FIG. 5, shows the respective dimensions, namely, the overall length of the nozzle 10a, the radius of the inlet 12a, R₁, the radius of the outlet 14a, R₂, the radius of the constriction 22a, Rₜ, (i.e. the minimum radius of the nozzle passage), the length, L₁, of the region Aa, and the length, L₂, of the region Ba.

TABLE 1

| | | | | | Length | Length |
|---|---|---|---|---|---|---|
| | | Inlet | Outlet | Constriction | of | of |
| | Nozzle | radius | radius | radius | region | region |
| | length | (R₁) | (R₂) | (Rt) | Aa | Bb |
| Example | (mm) | (mm) | (mm) | (mm) | (mm) | (mm) |
| 1 | 105 | 6 | 6 | 2 | 10 | 95 |
| 2 | 105 | 6 | 6 | 2 | 7.5 | 97.5 |

Thus, in the example illustrated in FIG. 5 and in Table 1, the throat region Aa comprises roughly 7-10% of the length of the passage of the nozzle, while the divergent region Ba comprises roughly 90-93% of the length of the passage of the nozzle. The radius R₁ of the inlet 12a and the radius R₂ of the outlet 14a of the illustrated examples are both 6 mm. Similarly, the radius R_{T} of the constriction 22a is 2 mm for both examples, or roughly 33% of the radius of the inlet 12a. As illustrated in FIG. 5, in one aspect, the inlet 12a and outlet 14a have the same radius dimension, whereas in the aspect illustrated in FIG. 1, radius R₁ is smaller than R₂.

It will be understood that the dimensions discussed above, and illustrated in FIG. 5 and Table 1, relate to only one aspect of the presently described nozzle and that such dimensions are not intended to limit the scope of the description in any way. Various other dimensions will be apparent to persons skilled in the art based on the teaching provided herein.

As also illustrated in FIG. 5, the radius, identified as “y”, of the various sections may be mathematically defined as a function of the distance, identified as “x”, along the length of the nozzle. For example, the relationship between y and x may be expressed by equation I as follows:

y(x)=A−B cos[(Cx−D)π] (I)

In equation I, the values for A, B, C, and D would vary based on the section, Aa or Ba. Examples of such values are shown below in Table 2:

TABLE 2

| | Radius | | | | |
|---|---|---|---|---|---|
| Section | function | A | B | C | D |
| Aa | Y₁(x) | 4 | −2 | 0.13333 | 0 |
| Ba | Y₂(x) | 4 | −2 | 0.01026 | −0.9231 |

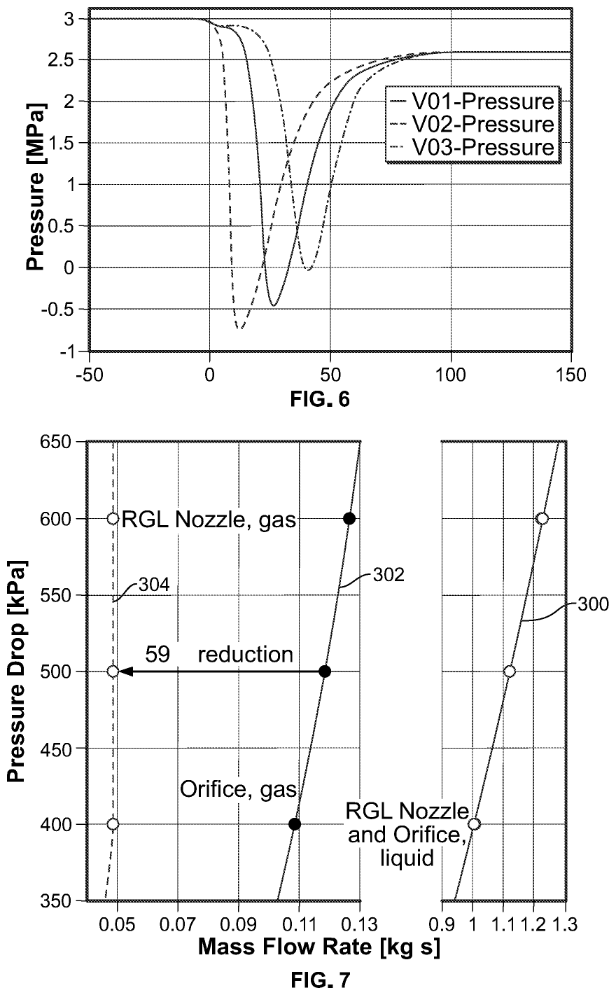

FIG. 6 illustrates the pressure differential over the length of the nozzle 10a illustrated in FIG. 5 and, in particular, the effect of varying the positioning of the constriction 22a. Curve V02 of FIG. 6 shows the pressure change across the length of the nozzle 10a, wherein the constriction 22a is positioned proximal to the inlet 12a as illustrated in FIG. 5. Curve V01 of FIG. 6 illustrates the pressure change across a nozzle similar to that shown in FIG. 5, but with constriction located generally mid-way along the length thereof. Finally, curve V03 illustrates the pressure change along the length of a nozzle wherein the constriction is positioned proximal to the outlet. As can be seen in FIG. 6, a noticeably greater pressure reduction is achieved with the nozzle structure illustrated in FIG. 5, that is, a nozzle 10a wherein the constriction 22a is located proximal to the inlet. As discussed above, obtaining a greater pressure reduction aids in achieving the desired gas choking effect. A similar flow management effect may be expected from the nozzle illustrated in FIG. 1 as well.

FIG. 7 illustrates a performance comparison between the nozzle 10a illustrated in FIG. 5 and a standard bevel-edged orifice (i.e. an orifice without any nozzle). As shown by curve 300, both the orifice and the nozzle 10a were found to achieve the same flowrate for a liquid component. However, in comparing curves 302 and 304, it is noted that using the nozzle 10a (curve 304) resulted in a roughly 59% reduction in the flowrate of a gas component as compared to the orifice alone (curve 302). Thus, as illustrated in FIG. 7, the use of the presently described nozzle on a port, as shown at 102 in FIG. 4, would serve to have no effect on the flowrate of liquids but would significantly choke the flow of gases.

Although the above description includes reference to certain specific embodiments, various modifications thereof will be apparent to those skilled in the art. Any examples provided herein are included solely for the purpose of illustration and are not intended to be limiting in any way. In particular, any specific dimensions or quantities referred to in the present description is intended only to illustrate one or more specific aspects are not intended to limit the description in any way. Any drawings provided herein are solely for the purpose of illustrating various aspects of the description and are not intended to be drawn to scale or to be limiting in any way. The scope of the claims appended hereto should not be limited by the preferred embodiments set forth in the above description but should be given the broadest interpretation consistent with the present specification as a whole. The disclosures of all prior art recited herein are incorporated herein by reference in their entirety.

1. A nozzle for controlling flow of a gas component of a fluid comprising a mixture of oil and gas, into a pipe, the pipe having at least one port along its length, the nozzle being adapted to be located on the exterior of the pipe and adjacent one of the at least one port, the nozzle comprising:
a body having an inlet, an outlet, and a fluid conveying passage extending between the inlet and outlet;
wherein, the passage comprises:
a first region having a converging-diverging region forming a throat, the throat being proximal to the inlet and defining a constriction in the passage; and,
a second region downstream of the first region having a gradually increasing cross-sectional area extending towards the outlet.

2. The nozzle of claim 1, wherein the constriction comprises a region of minimum cross-sectional area in the passage.

3. The nozzle of claim 1, wherein the constriction is sized to accelerate the gas component to sonic velocity.

4. The nozzle of claim 1, wherein the constriction comprises a curved passage extending between the inlet and the second region.

5. The nozzle of claim 1, wherein the constriction has a length forming a region of constant cross-sectional area.

6. The nozzle of claim 1, wherein the second region is defined by a wall having an angle of divergence less than or equal to about 15 degrees.

7. The nozzle of claim 1, wherein the passage further comprises a region of generally constant cross-sectional area between the second region and the outlet.

8. The nozzle of claim 1, wherein the diameters of the first and second openings are the same.

9. The nozzle of claim 1, wherein the length of the first region is less than or equal to about 10% of the length of the passage.

10. The nozzle of claim 1, wherein the radius of the constriction is about 33% the radius of the first or second opening.

11. An apparatus for controlling flow, from a subterranean reservoir, of a gas component, of a fluid comprising a mixture of oil and gas, the apparatus comprising a pipe having at least one port along its length, and at least one nozzle according to claim 1.

12. An apparatus for controlling flow, from a subterranean reservoir, of a gas component, of a fluid comprising a mixture of oil and gas, the apparatus comprising:
a pipe segment having at least one port along its length;
at least one nozzle located on the exterior of the pipe and adjacent one of the at least one port; and,
and a means for locating the nozzle on the pipe adjacent the port;
wherein the nozzle comprises:
a body having an inlet, an outlet, and a fluid conveying passage extending between the inlet and outlet;
wherein, the passage comprises:
a first region having a converging-diverging region forming a throat, the throat being proximal to the inlet and defining a constriction in the passage; and,
a second region downstream of the first region having a gradually increasing cross-sectional area extending towards the outlet.

13. The apparatus of claim 12, wherein the means for locating the nozzle comprises a clamp.

14. The apparatus of claim 12, wherein the apparatus further comprises a sand screen and wherein the nozzle is positioned to receive fluids passing through the sand screen prior to entering the port.

15. The apparatus of claim 12, wherein the constriction comprises a region of minimum cross-sectional area in the passage.

16. The apparatus of claim 12, wherein the constriction is sized to accelerate the gas component to sonic velocity.

17. The apparatus of claim 12, wherein the constriction of the nozzle comprises a curved passage extending between the inlet and the second region.

18. The apparatus of claim 12, wherein the constriction of the nozzle has a length forming a region of constant cross-sectional area.

19. The apparatus of claim 12, wherein the second region of the nozzle is defined by a wall having an angle of divergence less than or equal to about 15 degrees.

20. The apparatus of claim 12, wherein the passage of the nozzle further comprises a region of generally constant cross-sectional area between the second region and the outlet.

21. The apparatus of claim 12, wherein the diameters of the first and second openings of the nozzle are the same.

22. The apparatus of claim 12, wherein the length of the first region of the nozzle is less than or equal to about 10% of the length of the passage.

23. The apparatus of claim 12, wherein the radius of the constriction of the nozzle is about 33% the radius of the first or second opening.

24. A method of producing fluids from a subterranean reservoir, the method comprising:
a) flowing the fluids through a first, converging-diverging region of a nozzle; and
b) flowing the fluids through a second, diverging region of the nozzle, wherein the second region has a gradually increasing cross-sectional area.

25. The method of claim 24, wherein the fluids are flowed through a nozzle, wherein the nozzle comprises:
a body having an inlet, an outlet, and a fluid conveying passage extending between the inlet and outlet;
wherein, the passage comprises:
a first region having a converging-diverging region forming a throat, the throat being proximal to the inlet and defining a constriction in the passage; and,
a second region downstream of the first region having a gradually increasing cross-sectional area extending towards the outlet.

26. The method of claim 24, wherein the fluids are flowed through an apparatus comprising at least one nozzle, wherein the nozzle comprises:
a body having an inlet, an outlet, and a fluid conveying passage extending between the inlet and outlet;
wherein, the passage comprises:
a first region having a converging-diverging region forming a throat, the throat being proximal to the inlet and defining a constriction in the passage; and,
a second region downstream of the first region having a gradually increasing cross-sectional area extending towards the outlet.
